(19) United States
(12) Patent Application Publication
(10) Pub. No.: US 2023/0204062 A1
(43) Pub. Date: Jun. 29, 2023

(54) Particle board screw

(71) Applicant: Cheng-Yi Lin, Kaohsiung (TW)

(72) Inventor: Cheng-Yi Lin, Kaohsiung (TW)

(21) Appl. No.: 18/060,545

(22) Filed: Nov. 30, 2022

(30) Foreign Application Priority Data
Dec. 24, 2021 (TW) 110215404

(51) Int. Cl. F16B 25/00

(52) U.S. Cl. CPC F16B 25/0078; F16B 25/0015; F16B 25/0073; F16B 23/003

(57) ABSTRACT

A screw for particle board includes a head; a threaded shank; and a plurality of screw threads formed on the threaded shank. The head includes a slot on a top. The threaded shank is formed with the head and includes a shank and a tip at an end of the shank. The screw threads are formed on both the shank and the tip. The shank includes a plurality of longitudinal recesses and a plurality of longitudinal projections. Each recess is adjacent to each projection. Each screw thread is disposed between one of the recesses and the projection adjacent to the recess.

### FIELD OF THE INVENTION

The invention relates to screws and more particularly to a particle board screw comprising a threaded shank including longitudinal recesses for collecting chips and longitudinal projections for increasing driving capability, each recess being adjacent to each projection and each screw thread being disposed between one recess and the projection adjacent to the recess.

### BACKGROUND OF THE INVENTION

A conventional particle board screw is used to drive into a material having no female thread and includes an elongated threaded shank, a sharp tip, and rough threads.

However, the particle board screw has the following drawbacks as observed by the inventor:

It is difficult of driving a particle board screw into the material. Chips are generated while driving. The accumulated screws may increase resistance due to friction. That is why a user may have difficulties of driving the particle board screw into the material.

The force exerted by the particle board screw may be insufficient in screwing and it is often that several times of pulling the particle board screw out of the material and driving the particle board screw into the material again is required to finish the screwing. It is inconvenient in use.

Thus, the need for improvement still exists.

### SUMMARY OF THE INVENTION

It is therefore one object of the invention to provide a particle board screw comprising a head; a threaded shank; and a plurality of screw threads formed on the threaded shank; wherein the head includes a slot on a top; the threaded shank is formed with the head and includes a shank and a tip at an end of the shank; the screw threads are formed on both the shank and the tip; and the shank includes a plurality of longitudinal recesses and a plurality of longitudinal projections, each of recesses being adjacent to each projection and each of the screw threads being disposed between one of the recesses and the projection adjacent to the recess.

It is another object of the invention to provide a particle board screw comprising a head; a threaded shank; and a plurality of screw threads formed on the threaded shank; wherein the head includes a slot on a top; the threaded shank is formed with the head and includes a shank and a tip at an end of the shank; the screw threads are formed on both the shank and the tip; and the shank includes a plurality of longitudinal recesses, each of the recesses being disposed between two adjacent ones of the screw threads.

It is a further object of the invention to provide a particle board screw comprising a head; a threaded shank; and a plurality of screw threads formed on the threaded shank; wherein the head includes a slot on a top; the threaded shank is formed with the head and includes a shank and a tip at an end of the shank; the screw threads are formed on both the shank and the tip; and the shank includes a plurality of longitudinal projections, each of the projections being disposed between two adjacent ones of the screw threads.

The invention has the following advantages and benefits in comparison with the conventional art:

Use is smooth. In detail, chips are collected by recesses; friction of the chips is decreased; driving operation is facilitated; and it is labor saving.

Driving capability is increased. In detail, the plurality of curved ridges are formed on an outer surface of the head for increasing a turning force when driving the particle board screw into the material. The projections on the shank further increase the driving force. Jam is avoided.

The above and other objects, features and advantages of the invention will become apparent from the following detailed description taken with the accompanying drawings

### BRIEF DESCRIPTION OF THE DRAWINGS

FIG. 1 is a side elevation in part section of a particle board screw of a first preferred embodiment of the invention;

FIG. 2 is a view similar to FIG. 1 with the head being enlarged;

FIG. 3 is a top plan view of FIG. 1;

FIG. 4 is a bottom plan view in part section of FIG. 1;

FIG. 5 is a view similar to FIG. 1 with the threaded shank being enlarged;

FIG. 6 is a sectional view taken along line A-A of FIG. 5;

FIG. 7 is a side elevation in part section of a particle board screw of a second preferred embodiment of the invention;

FIG. 8 is a sectional view taken along line B-B of FIG. 7;

FIG. 9 is a side elevation in part section of a particle board screw of a third preferred embodiment of the invention; and

FIG. 10 is sectional view taken along line C-C of FIG. 9.

### DETAILED DESCRIPTION OF THE INVENTION

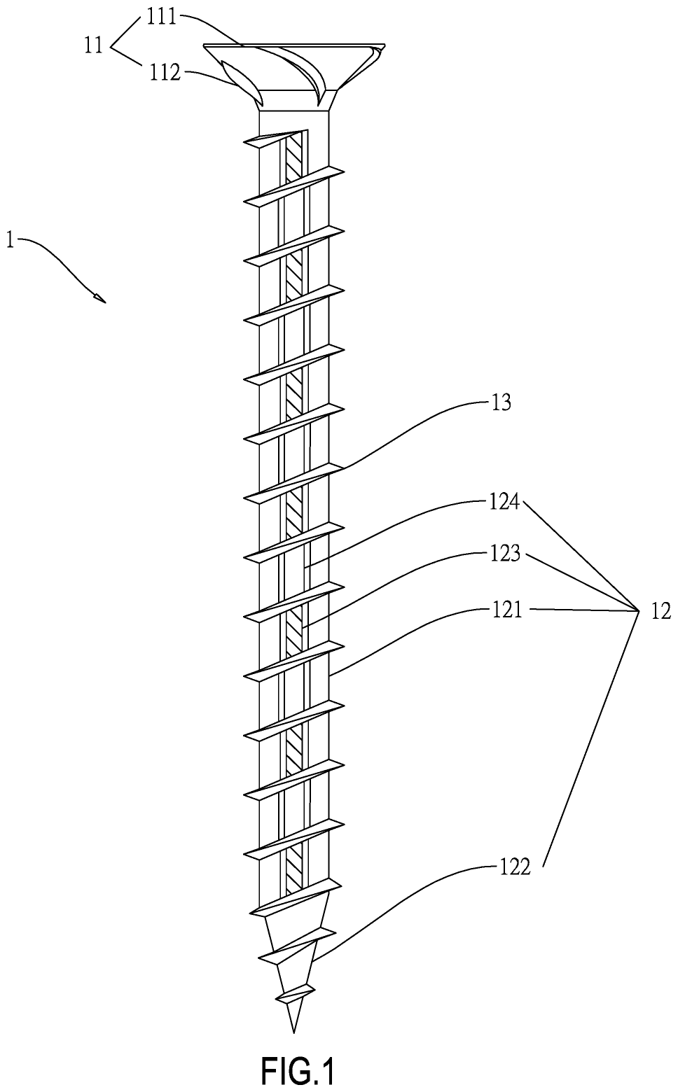

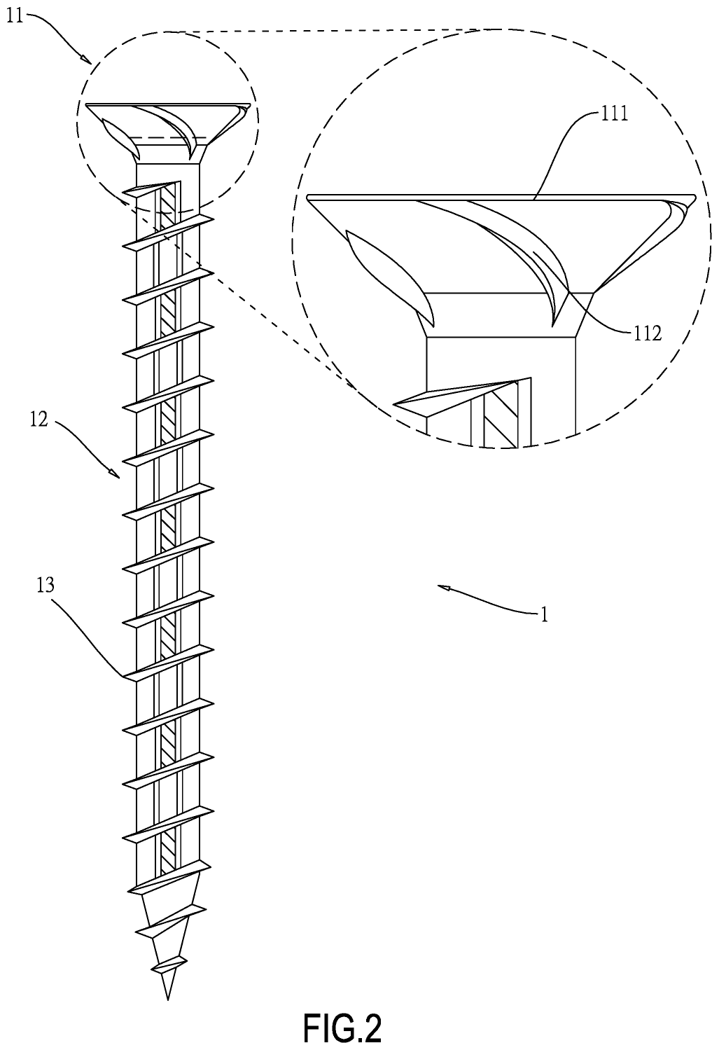

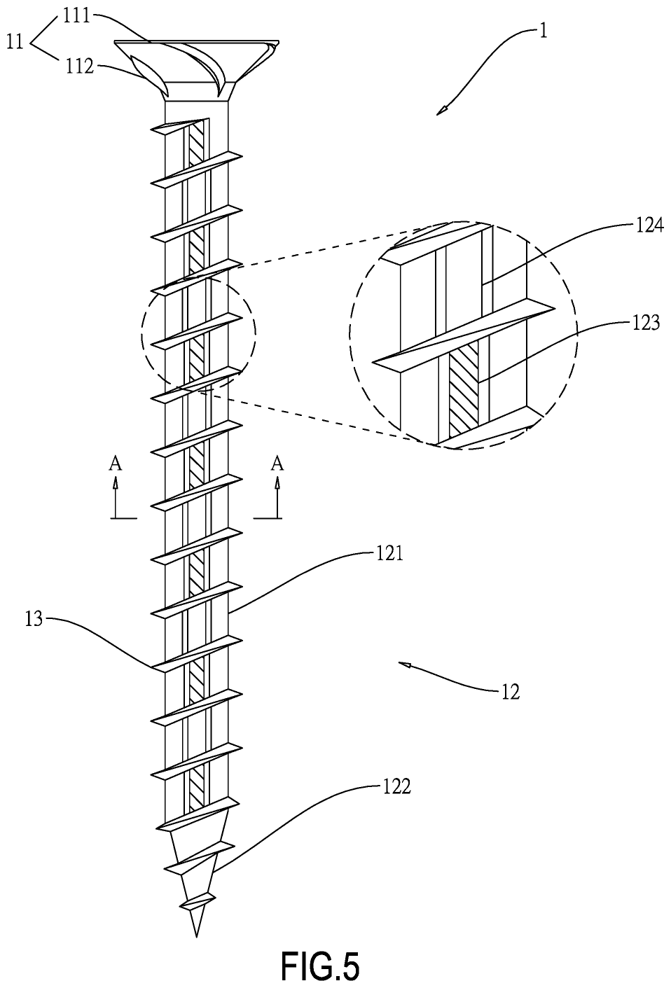

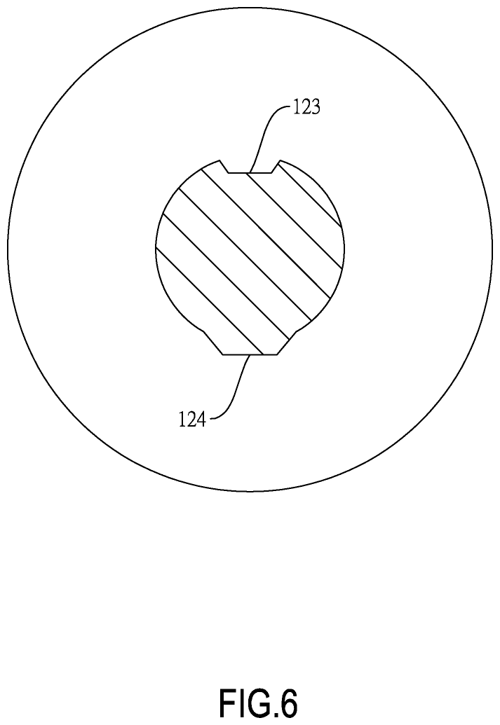

Referring to FIGS. 1 to 6, a particle board screw 1 of a=preferred embodiment of the invention comprises a head 11, a threaded shank 12, and a plurality of screw threads 13 formed on the threaded shank 12 as discussed in detail below.

The head 11 includes a slot 111 on a top. A user may put a tip of a tool (e.g., screwdriver) into the slot 11 before turning a handle of the tool. The threaded shank 12 is formed with the head 11 and includes a shank 121 and a tip 122 at an end of the shank 121. The tip 122 is used to drive into the material when driving the particle board screw 1. The screw threads 13 are formed on both the shank 121 and the tip 122. The screw threads 13 are used to drive into the material when driving the particle board screw. A pitch of the screw threads 13 is between 1.6 mm and 6.0 mm.

The invention is characterized below. In one of a plurality of sections, a recess 123 is adjacent to and aligned with a projection 124 longitudinally on the screw threads 13. The recess 123 is used to collect chips and decrease friction of the chips so that a labor saving effect is carried out when driving the particle board screw into the material in addition to convenient in use. The projection 124 is used to enlarge a hole being driven when driving the particle board screw into the material. Thus, the particle board screw can be used to drive into a hard material.

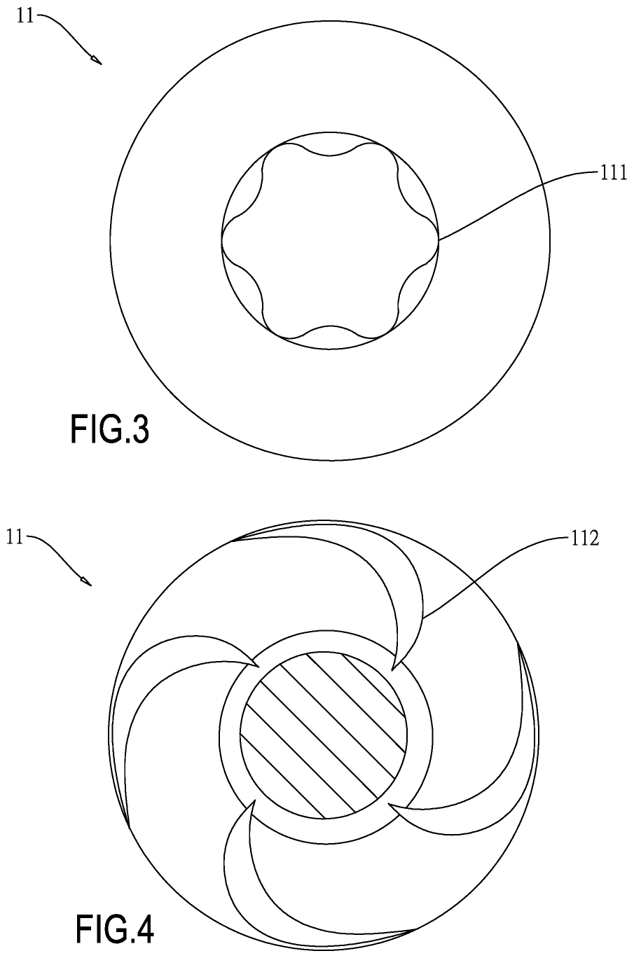

As shown in FIG. 3 specifically, the slot 111 is shaped as a star.

The head 11 further comprises a plurality of curved ridges 112 on an outer surface for increasing a turning force when driving the particle board screw into the material.

As shown, the recess 123 and the projection 124 are arranged in an alternate fashion. Specifically, on the screw threads 13 from the tip 122 to the head 11, the arrangement is two recesses 123, two projections 124, two recesses 123, two projections 124, etc. This arrangement has the advantages of allowing the two recesses 123 to collect chips, and allowing the projections 124 to enlarge the hole being driven so that the driving the particle board screw into the material is facilitated and the particle board screw can be used to drive into a hard material.

Alternatively, the recess 123 and the projection 124 are arranged in a non-alternate fashion.

The shapes of the recesses 123 and the projections 124 can be multi-sided such as truncated trapezoidal, rectangular, or triangular.

Specifically, chips generated by the tip 122 are collected by the recesses 123, the projections 124 enlarge the hole being driven, chips generated by the advancing projections 124 are collected to another recesses 123 and so on until both the threaded shank 12 and the head 11 are completely driven into the material.

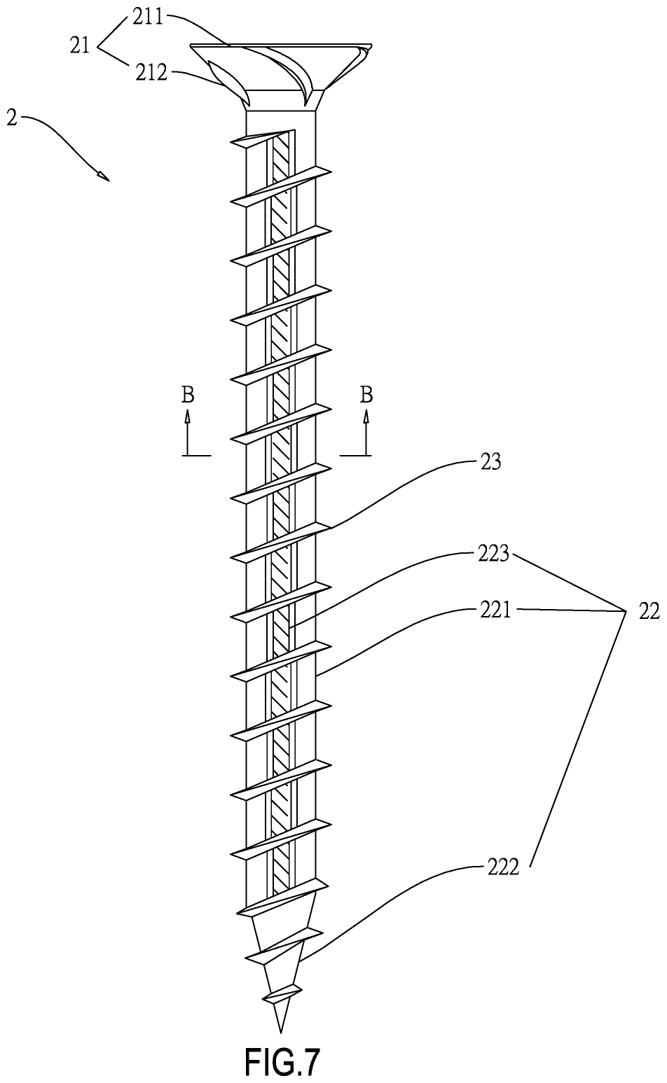

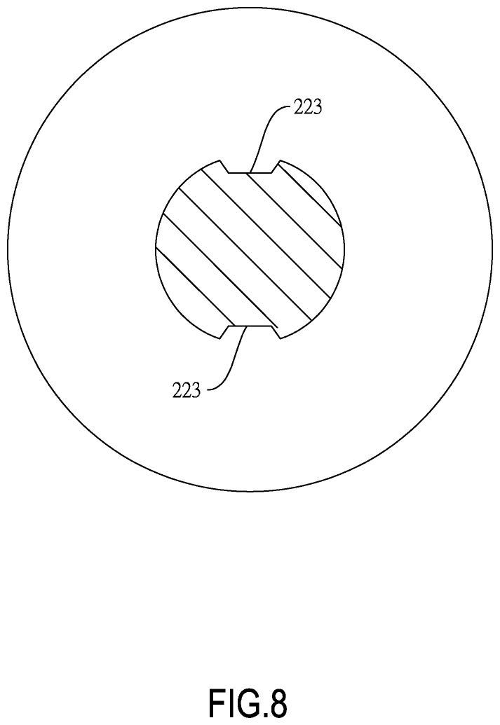

Referring to FIGS. 7 to 8, a particle board screw 2 in accordance with a second preferred embodiment of the invention is shown. The characteristics of the second preferred embodiment are substantially the same as that of the first preferred embodiment except the following: the projections are eliminated. The recesses 223 are aligned each other longitudinally. The recesses 223 are opposite transversely. In a driving operation, chips generated by the tip 222 are collected by the recesses 123. Further, the operation is labor saving.

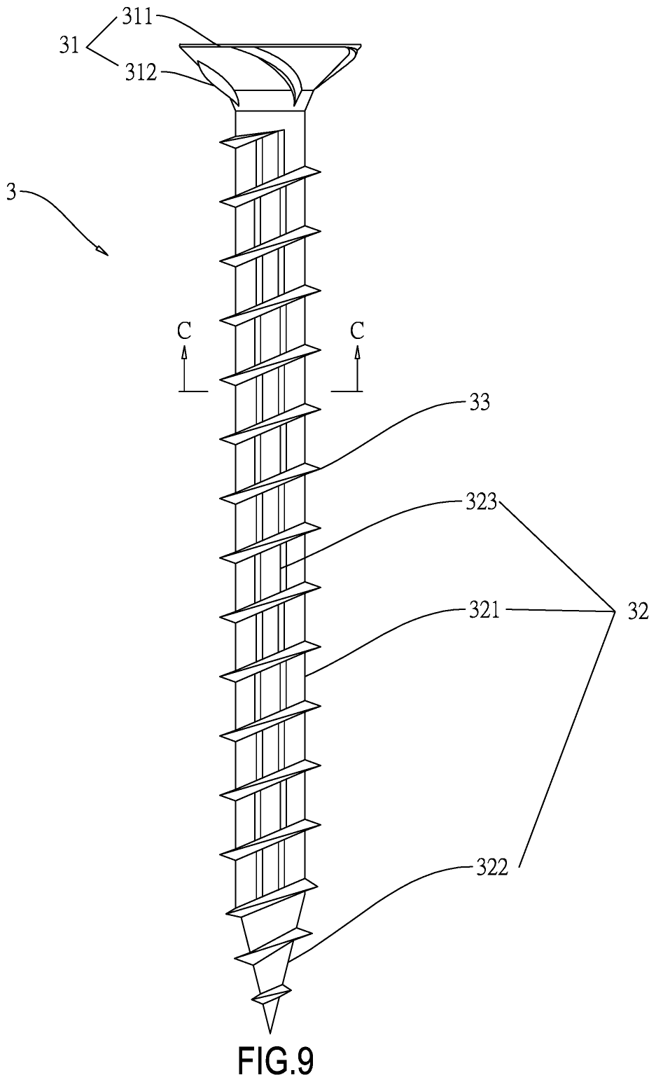

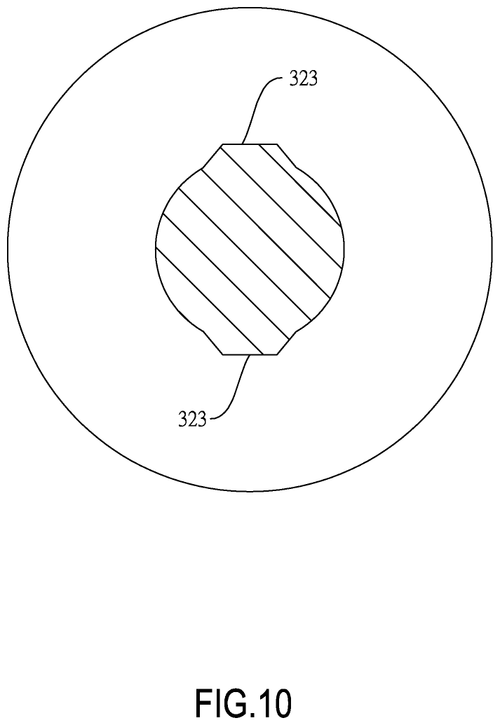

Referring to FIGS. 9 to 10, a particle board screw 3 in accordance with a third preferred embodiment of the invention is shown. The characteristics of the third preferred embodiment are substantially the same as that of the first preferred embodiment except the following: the recesses are eliminated. The projections 323 are aligned each other longitudinally. The projections 323 are opposite transversely. In a driving operation, the projections 323 enlarges a hole to driven. Further, the operation is smooth in addition to increased enlarging capability of the projections 323.

The invention has the following advantages and benefits in comparison with the conventional art:

Use is smooth. In detail, chips are collected by recesses; friction of the chips is decreased; driving operation is facilitated; and it is labor saving.

Driving capability is increased. In detail, the plurality of curved ridges are formed on an outer surface of the head for increasing a turning force when driving the particle board screw into the material. The projections on the shank further increase the driving force. Jam is avoided.

While the invention has been described in terms of preferred embodiments, those skilled in the art will recognize that the invention can be practiced with modifications within the spirit and scope of the appended claims.

What is claimed is:

1. A particle board screw comprising:
a head;
a threaded shank; and
a plurality of screw threads formed on the threaded shank;
wherein the head includes a slot on a top;
the threaded shank is formed with the head and includes a shank and a tip at an end of the shank;
the screw threads are formed on both the shank and the tip; and
the shank includes a plurality of longitudinal recesses and a plurality of longitudinal projections, each of recesses being adjacent to each projection and each of the screw threads being disposed between one of the recesses and the projection adjacent to the recess.

2. The particle board screw of claim 1, wherein the recesses and the projections are arranged in a non-alternate fashion.

3. The particle board screw of claim 1, wherein the head further comprises a plurality of curved ridges.

4. The particle board screw of claim 1, wherein a pitch of the screw threads is between 1.6 mm and 6.0 mm.

5. The particle board screw of claim 1, wherein shapes of the recesses and the projections are multi-sided.

6. A particle board screw comprising:
a head;
a threaded shank; and
a plurality of screw threads formed on the threaded shank;
wherein the head includes a slot on a top;
the threaded shank is formed with the head and includes a shank and a tip at an end of the shank;
the screw threads are formed on both the shank and the tip; and
the shank includes a plurality of longitudinal recesses, each of the recesses being disposed between two adjacent ones of the screw threads.

7. The particle board screw of claim 6, wherein the head further comprises a plurality of curved ridges.

8. The particle board screw of claim 6, wherein a pitch of the screw threads is between 1.6 mm and 6.0 mm.

9. The particle board screw of claim 6, wherein shapes of the recesses are multi-sided.

10. A particle board screw comprising:
a head;
a threaded shank; and
a plurality of screw threads formed on the threaded shank;
wherein the head includes a slot on a top;
the threaded shank is formed with the head and includes a shank and a tip at an end of the shank;
the screw threads are formed on both the shank and the tip; and
the shank includes a plurality of longitudinal projections, each of the projections being disposed between two adjacent ones of the screw threads.

11. The particle board screw of claim 10, wherein the head further comprises a plurality of curved ridges.

12. The particle board screw of claim 10, wherein a pitch of the screw threads is between 1.6 mm and 6.0 mm.

13. The particle board screw of claim 10, wherein shapes of the projections are multi-sided.
